(19) United States
(12) Patent Application Publication
(10) Pub. No.: US 2011/0017667 A1
(43) Pub. Date: Jan. 27, 2011

(54) MODULAR HEMOFILTRATION APPARATUS AND METHOD FOR CARRYING OUT NEONATAL AND PEDIATRIC CRRT

(75) Inventors: Michael J. Delmage, Napa, CA (US); Harold Peters, Snow Hill, NC (US); Tommy Cooper, Friendswood, TX (US); Steve Macha, Sugar Land, TX (US)

Correspondence Address: KNOBBE MARTENS OLSON & BEAR LLP, 2040 MAIN STREET, FOURTEENTH FLOOR, IRVINE, CA, 92614, US

(73) Assignee: TRANSVIVO INC., Richmond, CA (US)

(21) Appl. No.: 12/843,679

(22) Filed: Jul. 26, 2010

Related U.S. Application Data
(60) Provisional application No. 61/228,870, filed on Jul. 27, 2009.

(51) Int. Cl. B01D 61/32

(52) U.S. Cl. 210/646; 210/85

(57) ABSTRACT

An apparatus configured for carrying out CRRT on patients weighing up to about 20 kg incorporates a control unit having a blood pump and a plurality of fluid pumps mounted thereon, and a controller configured for operating the blood pump and fluid pumps, and an interactive operator control system including an operator interface screen operatively connected to the controller, the controller including software configured to operate the apparatus in response to operator input selections. The interactive operator control system includes operator inputs for setting patient weight, blood pump flow rate and fluid pump flow rates and the controller is configured to calculate and display maximum allowable fluid gain or loss based solely on patient weight settings between zero kg and about 20 kg and trigger warnings and alarms for selected or calculated levels of patient fluid gain or loss and stop operation of the pumps or termination of CRRT in response to patient fluid gain or loss in excess of the maximum.

### CROSS-REFERENCE TO RELATED APPLICATIONS

This application claims priority to U.S. Provisional Patent Application No. 61/228,870 filed Jul. 27, 2009 and incorporated herein by reference.

### BACKGROUND OF THE INVENTION

Hemodialysis systems have been designed to carry out blood therapy procedures such as slow continuous ultrafiltration (SCUF), continuous veno-venous hemofiltration (CVVH), continuous veno-venous hemodialysis (CVVHD) or continuous veno-venous hemodiafiltration (CVVHDF). These continuous renal replacement therapies, referred to as CRRT, are designed for removal of metabolic waste and excess fluid from patients in fluid overload and who need renal support. Presently available extracorporeal blood treatment apparatus often requires inconvenient and time consuming setup procedures including cleaning and/or replacing the blood and/or fluid tubing for different patients and for different therapies. Such procedures may require the apparatus to be removed from a patient's bedside or room to another location, or replacing an apparatus with a system that is set up and configured for carrying out a specific therapy.

U.S. Pat. No. 5,910,252 describes an apparatus configured for performing the different blood therapies and provides means for selecting one of the therapies to be carried out. The described apparatus is an assembly of all pumps, tubing, multiple fluid supply reservoirs, waste fluid container and filter cartridge necessary for performing any one of the selected blood therapies.

U.S. Pat. No. 6,200,485 describes another multipurpose hemofiltration system comprising an assembly of a blood filter cartridge, pumps, fluid reservoir and waste fluid container, components for comparing the weights of the fluid reservoir and waste fluid container and means for controlling the pump operations and rate in response to the compared weights during the therapy.

A Prismaflex™ system marketed by Gambro of Lakewood, Colo. offers selection of different CRRT therapies. The system allows the user to select a prepackaged, preassembled assembly incorporating all of the components including specific column and type of filter membrane or membrane filter surface area and all preconnected tubing for carrying out the selected therapy.

In U.S. patent application Ser. No. 12/183,537, filed Jul. 31, 2008 (TRANSVI.024A), there is described a modular hemofilter apparatus having removable panels for multiple and alternate blood therapy. The apparatus and system described in the aforesaid application provides a flexible treatment system characterized by a panel assembly having removable and disposable panels installed on the apparatus housing control unit whereby filter columns and/or tubing sets mounted on the panels may be replaced with filters and/or panels having different tubing configurations to accommodate different blood treatment therapies. The aforesaid application is incorporated herein in its entirety.

In U.S. patent application Ser. No. 12/577,578 filed Oct. 12, 2009 (TRANSVI.025A), the aforesaid modular hemofiltration apparatus with removable panels is further described including special and unique panel designs and tubing configurations. In U.S. patent application Ser. No. 12/577,513 filed Oct. 12, 2009 (TRANSVI.026A), there are disclosed components and features for readily and efficiently manually mounting and removing the panels and filter cartridges by an operator. In U.S. patent application Ser. No. 12/608,806 filed Oct. 29, 2009 (TRANVSVI.028A), there is described a modular hemofiltration apparatus with interactive operator instructions and control system characterized by operator inputs for selecting CRRT patient therapy, changing panel sets, replacing a filter cartridge and changing to a different patient therapy from a currently running patient therapy. The aforesaid applications are incorporated by reference herein in their entireties, respectively.

### SUMMARY OF THE INVENTION

The apparatus and method described herein provide a unique safety paradigm for CRRT therapies. This system is designed to ensure that warnings and alarms are keyed to the maximum fluid gain or loss calculation in such a way as to prevent volumetric errors beyond 10% of a patient's blood volume at all times. The system provides operator input for setting a patient weight from zero kg up to about 20 kg, blood pump flow rate and fluid pump flow rates, and calculates and displays maximum allowable fluid gain or loss based solely on the patient weight settings and triggers alarm and/or stops pump operation or termination of CRRT in response to patient fluid gain or loss in excess of the maximum. In some embodiments, the control system provides one or more warnings and/or alarms at predetermined fluid gain or loss levels below the calculated or selected maximum allowable. In other embodiments, the control system will stop pump operation after a certain number of warnings and/or alarms. In some embodiments, the control system provides for maximum fluid gain or loss over selected or predetermined time periods. In one embodiment, the control system provides for the maximum fluid gain or loss during a time period of about 3 hours. In one embodiment, the apparatus includes an interactive operator control system with inputs for operator setting replacement fluid rate, dialysate rate and net patient fluid removal rate with the controller automatically adjusting effluent removal rate to maintain operator set net fluid removal rate. In another embodiment, the interactive operator control system provides operator input for setting an excess fluid gain or loss limit below the calculated maximum. In another embodiment, the controller is configured to automatically trigger stopping pump operation or CRRT termination in response to fluid gain or loss in excess of the maximum setting. In yet another embodiment, the controller is configured to prevent operator input of flow rates in excess of a maximum input flow rate displayed on the interface screen. In another embodiment, the controller is configured to calculate and set the maximum allowable fluid gain or loss at 7 ml/kg for patient weight settings from zero kg to 20 kg. In another embodiment, the controller sets maximum allowable fluid gain or loss of 42 ml for patients weighing between zero kg to about 6 kg and maximum allowable fluid gain or loss of 7 ml/kg for patient weights from 6 kg to 20 kg. In another embodiment, the controller is configured to automatically adjust effluent removal rate to maintain operator set net fluid removal rate without adjusting operator set dialysate and replacement fluid flow rates. In another embodiment, the apparatus controller is configured to automatically set a zero net fluid removal in response to operator input of patient weight of between about zero kg and about 20 kg.

The aforesaid embodiments for carrying out neonatal and pediatric CRRT utilize an apparatus described herein which comprises a control unit with blood and fluid pumps, manually installed and replaceable panel kits mounted on the control unit having blood and fluid supply tubing on the panels, a replaceable filter cartridge, a controller CPU configured for operating the system including blood pump and fluid pumps and an interactive operator control system with an operator interface screen operatively connected to the controller. The controller CPU comprises one or more microprocessors provided with software configured to operate the apparatus in response to operator input selections and provide apparatus operating instructions and status of selected therapy parameters. The interactive operator control system is characterized by operator inputs for selecting a CRRT patient therapy, changing the panel sets, replacing the filter cartridge and changing to a different patient therapy from a currently running patient therapy. The operator input control panel also provides step-by-step operator instructions for changing the panel kit, replacing a filter cartridge and changing patient therapy during a running patient therapy. The interactive user control system utilizes an operator interface touch-screen with graphic controls whereby the operator may select system operations and is provided with instructions for carrying out the selected system operations and patient therapy sessions. The system also provides operator selection of temporary patient disconnect and later start procedure during a current selected therapy session as well as detailed operator instructions for carrying out the procedures. These as well as other components, features, parameters and advantages of the apparatus and its use will be further evident from the following detailed description.

### BRIEF DESCRIPTION OF THE DRAWINGS

FIGS. 1 and 2 are perspective views of the hemofiltration control apparatus showing the front and different sides of the panel assembly mounted on the control unit housing;

FIG. 3 is a schematic view of the modular blood therapy apparatus showing the interior panel fluid and blood tubing layout design with three fluid holding bags in fluid communication with the tubing;

FIG. 4 shows the interior panel surfaces with mounted tubing on blood supply and fluid tubing panels and a connected center panel and mounted hemofilter cartridge;

FIG. 5 shows an operator interface screen for inputting the patient weight; and

FIG. 6 shows the operator interface flow rate setup screen.

### DETAILED DESCRIPTION OF THE EMBODIMENTS

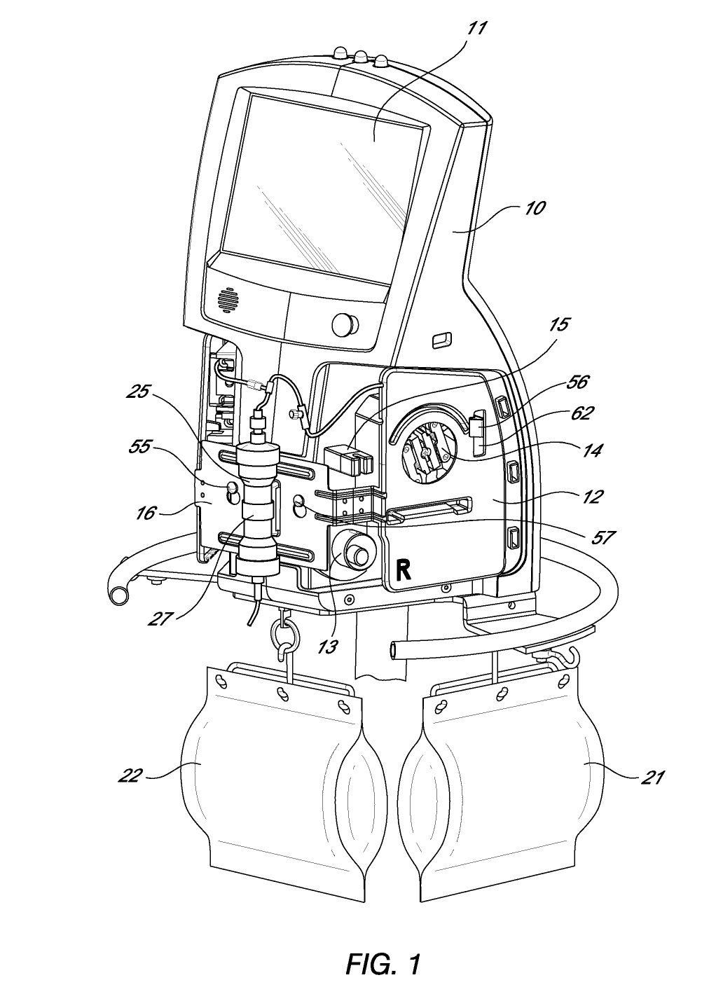

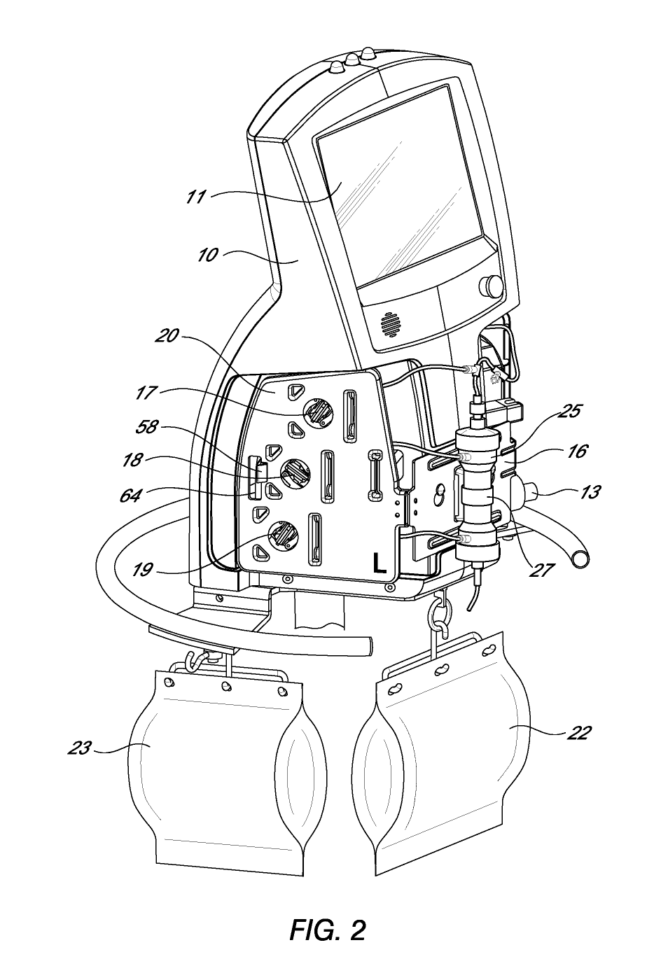

FIGS. 1 and 2 show a hemofiltration assembly including a control unit housing 10 with an operator interface touch-screen 11, illustrating opposite side views from the front corners of the apparatus. In FIG. 1, the blood side is shown with blood pump rotor 14 viewable through an opening in blood panel 12. In FIG. 2, three fluid pump rotors 17, 18, 19 are visible through viewing ports in fluid panel 20. On the front, a filter cartridge panel 16 with mounted hemofilter 25 is shown. The hemofilter, which is removable, is secured on the front panel with a filter cartridge strap 27 threaded through slots in the front panel. The strap may be conveniently provided with contact-type, adjustable securing components such as hook and loop (Velcro®) components which readily provide for securing different sized filter cartridges. Alternatively, the contact surfaces of the hemofilter and front panel may be provided with contact attaching means. The panels of the panel assembly set are mounted on the control unit housing by features and components as will be explained further hereinafter. In FIG. 1, an air detector 15 and return line clamp 13 are shown, and in FIGS. 1 and 2 fluid holding bags 21, 22, 23 are also shown.

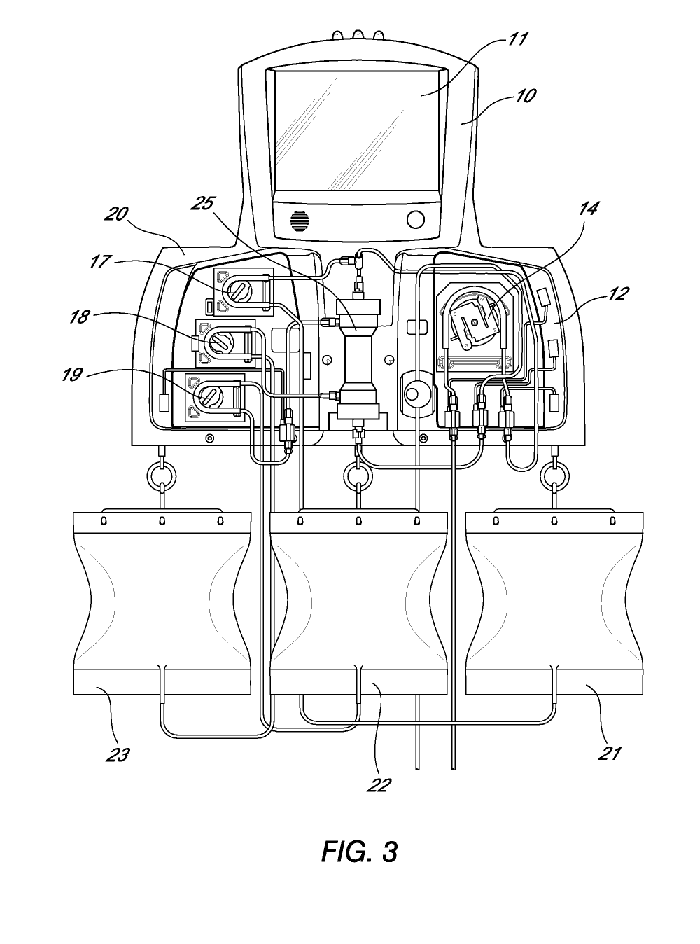

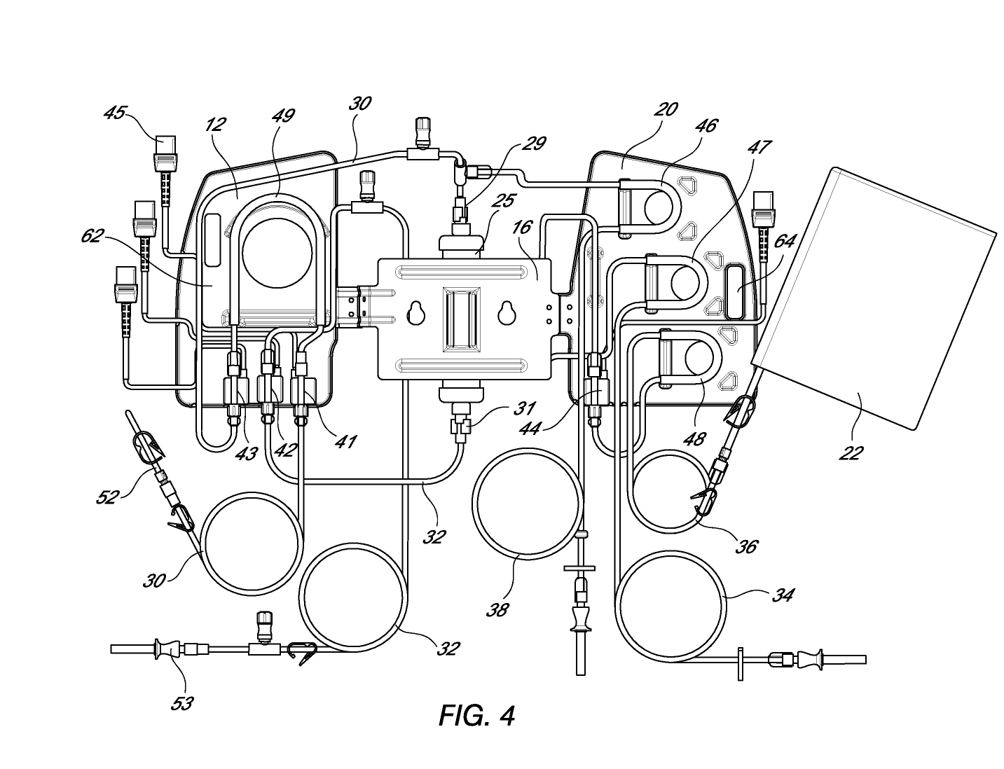

In FIGS. 3 and 4 there is shown the interior of the three-panel set with a tubing mounted on or adjacent to the interior panel surfaces and the relationship of the tubing as it is positioned for engagement with the respective blood pump and fluid pumps. Connections between sections or segments of the tubing with one another, with the filter cartridge, fluid pressure transducers, fluid supply containers and an effluent bag as well as to cannulae or catheters for directing blood to or from a patient are also shown.

The blood panel 12 includes blood supply tubing mounted along the interior, generally flat surface of the panel. An arched, upwardly slanted U-shape bend 49 of the blood supply tubing engages the rotors of blood pump 14 when the blood panel is securely mounted on the control unit housing. On the blood panel are positioned three pressure transducers 41, 42, 43 through which different sections of the blood supply tubing channels pass. The end of blood inlet line 30 is attached to a patient access device such as a needle cannula or catheter assembly 32 and includes a clamp for closing off the blood supply tubing. A blood pump 14 (FIGS. 1, 3) pumps blood along blood supply tubing blood inlet line 30 from the patient to the filter cartridge 25 via a blood inlet adapter 29. A blood return line 32 secured to an opposite end of the filter cartridge via a blood return adapter 31 includes segments directing the return line through the pressure transducer 42 and to a needle cannula assembly and/or catheter 53. Each of the pressure transducers has a pressure signal cable attached to a transducer plug 45, to be inserted in a socket on the control unit housing and for monitoring pressure signals from the respective pressure transducers along the blood inlet and return line segments.

The fluid side of the assembly comprises fluid panel 20 with tubing mounted along the generally flat interior surface. The fluid tubing is configured and shaped to engage three fluid pumps 17, 18, 19 secured to the control unit. Similar to the configuration of the blood supply tubing, three arched or U-shaped tubing segments 46, 47, 48 are provided to engage the rotors of the respective fluid pumps for driving fluids through the tubing. The different tubing segments and cooperating fluid pumps direct dialysate fluid, replacement fluid, saline/anticoagulant fluid, depending on the apparatus and blood treatment configuration, and effluent or waste fluid from the filter to the effluent container or bag. More specifically, replacement fluid line 38 directs replacement fluid from replacement fluid bag 21 via arched tubing section 46 to blood inlet line 30 and into the upper end of the filter cartridge 25. A second fluid tubing line directs dialysate fluid from dialysate fluid bag 23 into the side of the filter cartridge 25 via arched tubing section 47. A third fluid tubing section directs waste effluent from the filter cartridge to effluent fluid collection bag 22 via arched tubing section 48. A pressure transducer 44 is also positioned on the fluid panel. In a preferred embodiment, all of the pressure transducers are positioned on the respective panels such that when the panels are securely mounted on the control unit housing, the pressure transducers are at the same vertical elevation so that accurate pressure readings can be taken and compared, without further adjustment, which would otherwise be required to compensate for differences in transducer elevations. More specific and detailed descriptions of the tubing layouts on the respective blood and fluid panels are described and shown in aforesaid U.S. patent application Ser. No. 12/183,527 (TRANSVI.024A) and U.S. patent application Ser. No. 12/577,578 (TRANSVI.025A).

The above-described apparatus is configured for carrying out selected CRRT blood therapy procedures including SCUF, CVVH, CVVHT and CVVHDF. Such procedures are well known in the art and further described in detail in the aforesaid applications, particularly TRANSVI.028A. As previously described, the apparatus including the interactive operator system and interface screen operatively connected to the controller provide for selecting and carrying out the different therapies, as well as for terminating a currently running therapy and selecting an alternate therapy. As also previously described, the operator interface screen provides operator instructions for carrying out the therapies, including setting up the apparatus for selectively changing or installing the fluid bags during setup and running patient therapy, replacing panel kits and/or a filter cartridge during a running patient therapy session, and the like.

In carrying out pediatric and neonatal CRRT operating the apparatus at diminished blood and fluid flows from those typically used for adult therapy assists in preventing excessive fluid removal (effluent) and gives an operator substantially better control of net fluid removal. For example, for most adult CRRT therapy, a net removal setting of 0-2,000 ml/hr and a 3-hour excess fluid gain or loss limit of 125-400 ml is typically allowable on a flow rate setup by the operator. However, for neonatal and pediatric patients up to 20 kg range, such high net removal and excess fluid gain or loss limits are excessive.

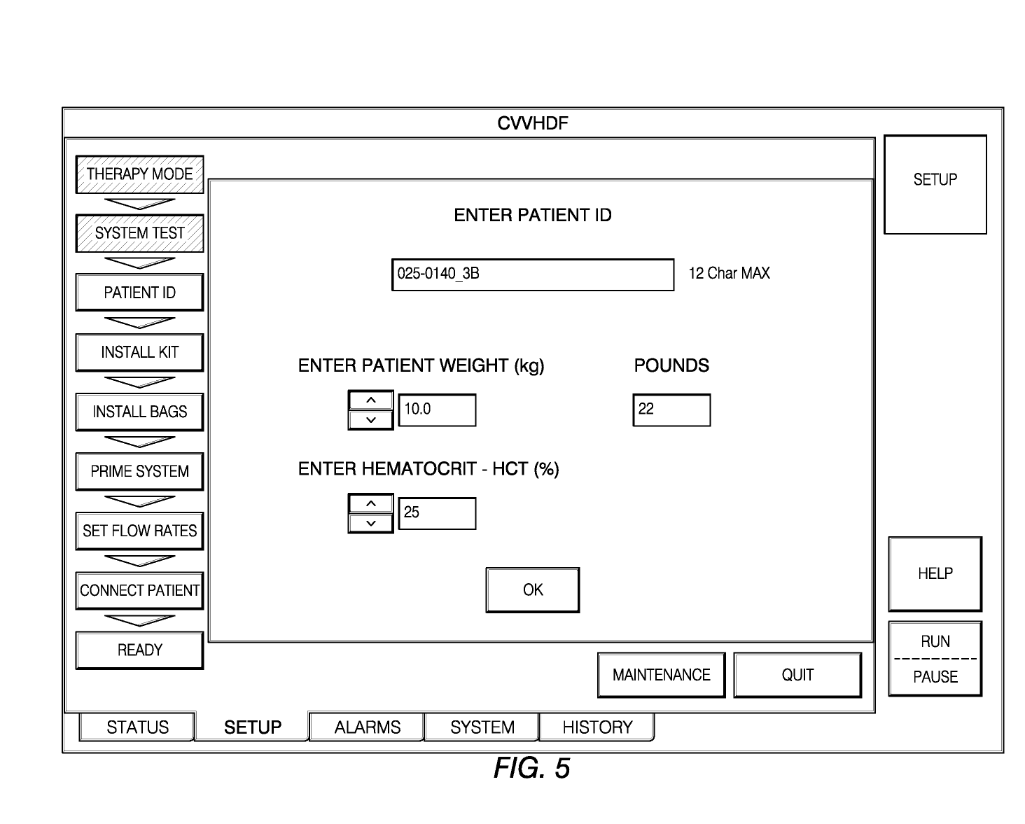

In the apparatus described herein, in one embodiment, the interactive operator control system provides operator inputs for setting a patient weight at between zero kg and about 20 kg. Such an operator interface screen is illustrated in FIG. 5. To enter the neonatal or pediatric patient weight, the operator touches the “setup” tab on the patient ID screen and enters the patient weight. In response to such input, the controller is configured to calculate and display a maximum allowable fluid gain or loss based on the patient weight settings. However, the apparatus need not be limited to neonatal and pediatric patient use, and preferably allows for input of adult patient weight settings and calculates maximum allowable fluid gain or loss, warnings, alarms, pump stop and CRRT termination as well.

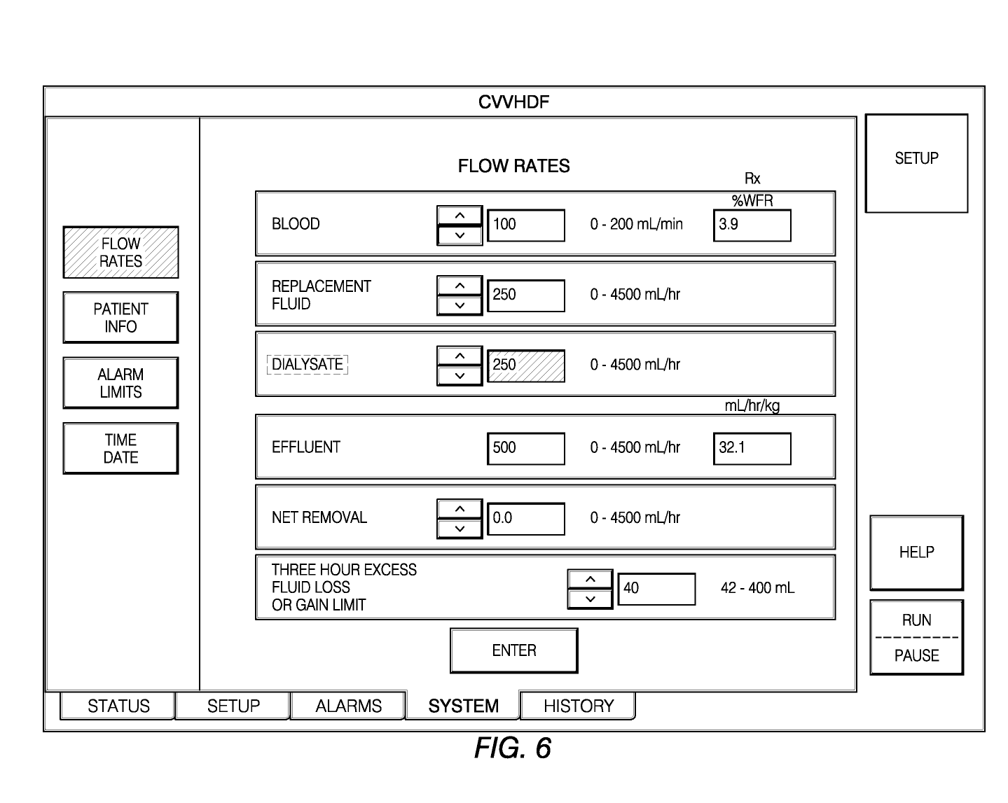

In FIG. 6, the flow rate setup screen is also shown, which screen appears when the operator presses the “system” tab. With the neonatal or pediatric patient weight set between zero kg and about 20 kg (FIG. 5), the controller is configured to calculate and display on the flow rate setup screen the maximum allowable fluid gain or loss based solely on the patient weight settings. Moreover, the controller is configured to trigger an alarm and/or stop operation of all pumps or termination of a CRRT session in response to patient fluid gain or loss in excess of the maximum allowable.

In some embodiments, the controller is configured to calculate, set and trigger one or more warnings and/or alarms for patient fluid gains or losses below the maximum allowable, thereby alerting an operator. For example, the controller may be configured to trigger a warning when a first fluid gain or loss is exceeded and trigger an alarm when a second, greater volume of fluid is gained or lost. Such warnings and alarms may also be set for fluid gains or losses over selected time periods. The controller may also be configured to stop the pump and terminate CRRT after a number of warnings and/or alarms.

In one embodiment, the controller is configured to trigger a warning or alarm as the 3-hour fluid gain or loss approaches 7 ml/kg of patient body weight for patient weight of 20 kg or less. In another embodiment, the controller is configured to trigger a warning or alarm and/or shutting down pump operation of the 3-hour fluid gain or loss in excess of 42 ml for patient weight settings of 6 kg or less. In yet another embodiment, the controller is configured to trigger a warning or alarm and/or shut down pump operation of 3-hour fluid gain or loss in excess of 140 ml for any patient weight settings of 20 kg or more.

In FIG. 6, the maximum allowable fluid gain or loss is shown as a 3-hour excess fluid loss or gain limit. However, in other embodiments, the apparatus may be configured for a different maximum fluid gain or loss time period and the flow rate screens modified accordingly.

In another embodiment, the controller is configured to trigger a warning in response to patient net fluid gain or loss in excess of about 20 ml and trigger an alarm in response to patient net fluid gain or loss in excess of about 30 ml at patient weight settings of between zero kg and about 10 kg. In another embodiment, the controller is configured to trigger a warning in response to patient net fluid gain or loss in excess of about 35 ml and trigger an alarm in response to patient net fluid gain or loss in excess of about 50 ml at patient weight settings of between about 10 kg and about 15 kg. In another embodiment, the controller is configured to trigger a warning in response to patient net fluid gain or loss in excess of about 50 ml and trigger an alarm in response to patient net fluid gain or loss in excess of about 80 ml at patient weight settings of between about 15 kg and about 20 kg. In yet another embodiment, the controller is configured to trigger a warning in response to patient net fluid gain or loss in excess of about 60 ml and an alarm at fluid gain or loss in excess of about 100 ml at patient weight settings above about 20 kg.

In one embodiment, the controller provides for a maximum allowable fluid gain or loss of between about 30 ml and about 40 ml at patient weight settings of between zero kg and about 10 kg, between about 50 ml and about 70 ml at patient weight settings of between about 10 kg and about 15 kg, and between about 80 ml and about 120 ml at patient weight settings of between about 15 kg and about 20 kg. Again, the controller is configured to calculate and display such allowable maximum fluid gain or loss. In another embodiment, the interactive operator control system prevents operator input for setting a fluid gain or loss in excess of the computer provided allowable maximum. In yet another embodiment, the operator control system provides for operator input for setting such 3-hour excess fluid gain or loss limit below the computer provided allowable maximum. Again, as previously described, the 3-hour time limit embodiment shown may be changed to meet other standards or preferred time periods.

In another embodiment, the controller is configured to terminate a CRRT session in response to operator restarting pumps multiple times. For example, in an embodiment, where the controller stops pump operation in response to net fluid gain or loss in excess of the maximum allowable calculated for a patient weight setting, the operator may restart the pumps to continue therapy. However, the controller may be configured to allow such restarts only a limited number of times, e.g., 3-10 times, after which it will not allow any further restart and/or will initiate termination procedures for the CRRT session.

As illustrated in FIG. 6, the interactive operator control system input provides for setting replacement fluid rate, dialysate rate and net removal rate. In one embodiment, the controller is configured to automatically adjust the effluent removal rate to maintain the operator set net fluid removal rate based on the formula:

net removal=effluent removed−dialysate added−replacement fluid added,

without adjusting operator set dialysate and replacement fluid flow rates. In response to these operator inputs, the controller sets the appropriate fluid pump flow for carrying out the CRRT. In one embodiment, the controller is also configured to calculate and display on the interface screen maximum operator input flow rates for blood, dialysate, replacement fluid and net fluid removal in response to operator patient weight input settings of between about 5 kg and about 20 kg. Moreover, in another embodiment, the controller is configured to prevent operator input of any flow rate in excess of aforesaid maximum input flow rates displayed. In another embodiment, the maximum flow rates for patients weighing zero kg to 20 kg are:

blood—100 ml/minute,

dialysate fluid—250 ml/hr, and

replacement fluid—250 ml/hr.

Such a controller configuration still allows ample latitude for operator controlling desired blood and/or flow rates but prevents an operator from inadvertently or unknowingly prompting the apparatus to carry out neonatal or pediatric CRRT sessions at excessive flow rates as well as alarming an operator and shutting down the therapy session in response to excessive fluid gain or loss limits, the latter which may be caused by pump or other apparatus malfunction or failure.

In yet another embodiment, the controller is configured to set the net removal at 0 or up to a maximum of 2000 ml/hr. In typical adult CRRT sessions, net removal is set at, for example, between about 100 ml and about 500 ml or even up to 1,000 ml/hr. However, for pediatric and neonatal CRRT, such net removals are excessive, in view of the small range of error allowable for such patients with relatively small circulatory volumes. Similarly, the reduced replacement fluid and dialysate flow rates, as well as blood flow, gives the operator or physician flexibility in changing such flow rate within the parameters of the aforesaid maximum settings.

It is to be understood that the aforesaid flow rates have been described regarding CVVHD therapy, as shown in FIG. 6 and described further herein. However, the apparatus and the method are not limited to a CVVHDF setup and may be applied to any of the aforesaid CRRT therapies for which the apparatus is capable of carrying out.

The computer is also configured to ensure that the panel kit installed is appropriate for the selected treatment. As well, the computer is configured to ensure that the appropriate filter has been installed. This is accomplished by a barcode scanner feature of the control unit for scanning barcodes on the panel kit and filter. The hemofilter used for neonatal and pediatric CRRT is smaller than that required for adult patients. Examples of useful hemofilters are Minntech HF 400, HF 700 or HF 1200, or other equivalent filters.

What is claimed is:

1. An apparatus configured for carrying out Continuous Renal Replacement Therapies (CRRT) on patients weighing less than about 20 kg, comprising:
a control unit comprising:
a blood pump and a plurality of fluid pumps mounted thereon;
a controller configured for operating said blood pump and said fluid pumps; and
an interactive operator control system comprising an operator interface screen operatively connected to said controller, wherein said controller comprises software configured to operate said apparatus in response to operator input selections; and
a replaceable panel kit configured to be manually mounted on and removed from said control unit comprising
a blood panel;
a fluid panel comprising blood and fluid supply tubing, respectively, secured thereon and in operating engagement with said blood pump and said fluid pumps, respectively;
a filter cartridge panel secured to said blood panel and said fluid panel; and
a replaceable filter cartridge mounted thereon,
wherein said interactive operator control system includes operator inputs for setting patient weight, blood pump flow rate and fluid pump flow rates; and
wherein said controller is configured to calculate and display maximum allowable fluid gain or loss based solely on patient weight settings between zero kg and about 20 kg and trigger an alarm and/or stop operation of said pumps or termination of CRRT in response to patient fluid gain or loss in excess of said maximum allowed fluid gain or loss.

2. An apparatus of claim 1 wherein said controller provides for maximum allowable fluid gain or loss of about 7 ml/kg for patient weight settings between zero kg and about 20 kg.

3. An apparatus of claim 1 wherein said controller provides for maximum allowable fluid gain or loss of about 42 ml for patient weight settings between zero kg and about 6 kg.

4. An apparatus of claim 3 wherein said controller provides for maximum allowable fluid gain or loss of about 7 ml/kg for patient weight settings between about 6 kg and about 20 kg.

5. An apparatus of claim 4 wherein said controller provides for maximum allowable fluid gain or loss of about 140 ml for patient weight settings above about 20 kg.

6. An apparatus of claim 1 wherein the controller is configured to set a first and a second net fluid gain/loss and trigger a warning signal when patient fluid gain or loss is in excess of said first net fluid gain/loss and trigger an alarm when fluid gain or loss is in excess of said second net fluid gain/loss.

7. An apparatus of claim 1 wherein said fluid pumps comprise a dialysate fluid pump, a replacement fluid pump and an effluent pump, wherein said operator inputs comprise replacement fluid rate, dialysate rate and net fluid removal rate and wherein said controller automatically adjusts effluent removal rate without adjusting operator set dialysate flow rate and replacement fluid flow rate to maintain operator set net fluid removal based on the formula:
net removal=effluent removed−dialysate added−replacement fluid added.

8. An apparatus of claim 1 wherein said controller is configured to trigger a warning in response to net fluid gain or loss in excess of about 20 ml and trigger said alarm in response to net fluid gain or loss in excess of about 30 ml at patient weight settings of between zero kg and about 10 kg.

9. An apparatus of claim 1 wherein said controller is configured to trigger a warning in response to net fluid gain or loss in excess of about 35 ml and trigger said alarm in response to net fluid gain or loss in excess of about 50 ml at patient weight settings of between about 10 kg and about 15 kg.

10. An apparatus of claim 1 wherein said controller is configured to trigger a warning in response to net fluid gain or loss in excess of about 50 ml and trigger said alarm in response to net fluid gain or loss in excess of about 80 ml at patient weight settings of between about 15 kg and about 20 kg.

11. An apparatus of claim 1 wherein said controller triggers a warning in response to net fluid gain or loss in excess of about 60 ml and trigger said alarm in response to net fluid gain or loss in excess of about 100 ml at patient weight settings above about 20 kg.

12. An apparatus of claim 1 wherein the controller provides for maximum allowable fluid gain or loss of between about 30 ml and about 40 ml at patient weight settings of between zero kg and about 10 kg.

13. An apparatus of claim 1 wherein the controller provides for maximum allowable fluid gain or loss of between about 50 ml and about 70 ml at patient weight settings of between about 10 kg and about 15 kg.

14. An apparatus of claim 1 wherein the controller provides for maximum allowable fluid gain or loss of between about 80 ml and about 120 ml at patient weight settings of between about 15 kg and about 20 kg.

15. An apparatus of claim 1 wherein said interactive operator control system includes operator input for setting an excess fluid gain or loss limit below said allowable maximum.

16. An apparatus of claim 15 wherein said controller is configured to automatically trigger said CRRT termination in response to set fluid gain or loss in excess of said setting during a time period of up to about 3 hours.

17. An apparatus of claim 1 wherein said controller is configured to prevent operator input for setting a fluid gain or loss in excess of said maximum.

18. An apparatus of claim 1 wherein said interactive operator control system includes an operator interface screen, and wherein said controller is configured to calculate and display on said interface screen maximum operator input flow rates for blood, dialysate, replacement fluid and net fluid removal in response to operator patient weight input settings.

19. An apparatus of claim 18 wherein said controller is configured to prevent operator input of flow rates in excess of the maximum input flow rates displayed.

20. An apparatus of claim 18 wherein the maximum flow rates for patients weighing up to about 20 kg are:
blood—100 ml/min
dialysate fluid—250 ml/hr, and
replacement fluid—250 ml/hr.

21. A method of operating and controlling a Continuous Renal Replacement Therapies (CRRT) apparatus, said apparatus comprising:
a control unit comprising a blood pump and a plurality of fluid pumps mounted thereon, a panel kit mounted on said control unit comprising a blood panel, a fluid panel having blood and fluid supply tubing, respectively, secured thereon and in operating engagement with said blood pump and said fluid pumps, respectively, and a filter cartridge panel secured to said blood panel and said fluid panel and having a replaceable filter cartridge mounted thereon, said control unit including a controller configured for operating said blood pump and said fluid pumps, and an interactive operator control system including an operator interface screen operatively connected to said controller, said controller including software configured to operate said apparatus in response to operator input selections, provide apparatus operating instructions, and wherein said interactive operator control system comprises an operator interface screen having touch controls for selecting system operations and for providing operator instructions for carrying out selected system operations and patient therapy session settings for patient weight, blood pump and fluid pump flow rates and net fluid removal, wherein said method comprises:
providing controller software configured to calculate and set maximum patient fluid gain or loss of about 7 ml per kg of patient weight settings of between zero kg and about 20 kg, and
configuring said computer to stop operation of said pumps and/or trigger CRRT termination in response to patient fluid gain or loss in excess of said maximum over a time period of 3 hours, and
setting a patient weight of between about zero kg and about 20 kg on said operator interface screen.

22. A method of claim 21 further comprising configuring said controller to calculate and display on said operator interface screen maximum blood flow, dialysate flow, replacement fluid flow and net fluid removal in response to operator patient weight settings.

23. A method of claim 21 further comprising configuring said controller to prevent operator setting a blood flow or fluid flow in excess of any maximum flow displayed.

24. A method of claim 23 further comprising inputting replacement fluid rate, dialysate rate and net fluid removal rate and configuring said controller to automatically adjust effluent removal without adjusting operator dialysate flow and replacement fluid flow settings to maintain operator setting of net fluid removal based on the formula:
net removal=effluent removed−dialysate added−replacement fluid added.
